(19) United States
(12) Patent Application Publication
(10) Pub. No.: US 2026/0119876 A1
(43) Pub. Date: Apr. 30, 2026

(54) SYSTEMS AND METHODS FOR AUTOMATED AUGMENTATION OF DIFFERENTIAL EQUATION MODELS USING HYBRID LEARNING AND SYMBOLIC RECONSTRUCTION

(71) Applicant: JuliaHub, Inc., Boston, MA (US)

(72) Inventors: Christopher Rackauckas, Cambridge, MA (US); Sebastian Micluta-Câmpeanu, Bucharest (RO); Anas Abdelrehim, Toronto (CA)

(21) Appl. No.: 19/367,962

(22) Filed: Oct. 24, 2025

Related U.S. Application Data
(60) Provisional application No. 63/711,752, filed on Oct. 25, 2024.

(51) Int. Cl. G06N 3/082; G06F 17/13; G06N 3/048

(52) U.S. Cl. CPC G06N 3/082; G06F 17/13; G06N 3/048

(57) ABSTRACT

The present disclosure provides a computer-implemented system for automated augmentation of differential equation models. The system stores differential equations representing mechanistic behavior of physical or computational processes and constructs a hybrid computational solver by embedding a trainable universal approximator with adjustable parameters into the differential equations, where approximator outputs augment time derivatives during numerical integration. An iterative training process adjusts parameters through numerical integration, monitors integration failures, assigns infinite penalty values to loss functions when failures occur, and computes gradients using automatic differentiation otherwise. The system computes sensitivity metrics via Jacobian matrix evaluation, classifies input/output subsets as significant based on threshold-exceeding sensitivity metrics, generates a reduced approximator operating on classified subsets, and replaces the universal approximator with the reduced version to create an optimized solver.

### CROSS-REFERENCE TO RELATED APPLICATIONS

This application claims priority to U.S. Application No. 63/711,752, titled AUTOMATED SPARSE MODEL AUGMENTATION, filed Oct. 25, 2024, which is hereby incorporated by reference in its entirety.

### TECHNICAL FIELD

The present disclosure relates to computer-implemented methods and systems for modeling physical systems, and more particularly to methods for automatically augmenting mechanistic models of physical processes with learned corrections that are then converted into interpretable symbolic forms suitable for industrial use.

### BACKGROUND

Machine learning and computational modeling serve as tools for understanding complex dynamical systems across fields including fluid dynamics, biological systems, and industrial process control. Traditional modeling approaches employ either mechanistic models based on first principles or data-driven models that learn patterns from observations. Mechanistic models provide interpretability through differential equations grounded in physical laws. Data-driven approaches can capture complex patterns without requiring detailed physics knowledge.

Mechanistic models face limitations when the underlying physics are incompletely understood or when simplifying assumptions introduce systematic errors. Data-driven models may lack physical interpretability and can produce predictions that violate known physical constraints. Hybrid approaches that combine mechanistic knowledge with data-driven corrections attempt to address these limitations by embedding trainable components within differential equation systems.

In industrial applications, mechanistic models often exhibit systematic prediction errors due to incomplete knowledge of underlying phenomena. Turbulence closure models in computational fluid dynamics make simplifying assumptions that introduce errors in separated flow regions. Enzyme kinetic models in systems biology may omit complex regulatory mechanisms. Chemical reactor models may not fully capture heat transfer effects or catalyst deactivation. Thermal management models for electric vehicle batteries may inadequately represent aging effects or temperature-dependent behavior.

Data-driven augmentation of these models faces several technical challenges. Training universal approximators embedded within differential equation solvers often encounters numerical instabilities that cause solver crashes during optimization. The resulting hybrid models may contain thousands of parameters in neural networks, making them computationally expensive and difficult to interpret for industrial deployment. Identifying which components of a mechanistic model require augmentation typically requires manual analysis by domain experts.

Current approaches lack automated methods for determining which inputs and outputs of embedded approximators contribute most to model accuracy. Extracting interpretable mathematical expressions from trained neural networks remains challenging, limiting the adoption of hybrid models in industrial settings where interpretability and computational efficiency are required.

### SUMMARY

According to an aspect of the present disclosure, a computer-implemented system for automated augmentation of differential equation models is provided. The system comprises at least one processor. The system comprises a memory storing a system of differential equations representing mechanistic behavior of a physical or computational process. The memory further stores executable instructions that, when executed by the at least one processor, cause the system to construct, in the memory, a hybrid computational solver by embedding a trainable universal approximator comprising a plurality of adjustable parameters into the system of differential equations such that outputs of the universal approximator computationally augment time derivatives of differential variables during numerical integration. The instructions cause the system to execute an iterative training process that adjusts the plurality of parameters by performing numerical integration of the hybrid computational solver over time intervals specified by training data, monitoring the numerical integration for integration failures or numerical instabilities, assigning an infinite penalty value to a loss function in response to detecting an integration failure or numerical instability to computationally redirect parameter optimization away from destabilizing parameter regions, and computing gradients of the loss function with respect to the plurality of parameters using automatic differentiation when no integration failure is detected. Computationally redirecting parameter optimization away from destabilizing parameter regions includes computing a loss function value and providing the loss function value to an optimization algorithm, wherein detecting an integration failure causes assignment of an infinite penalty value as the loss function value that causes an optimization algorithm to reject the corresponding parameter update. The instructions cause the system to compute, using the at least one processor, sensitivity metrics by evaluating a Jacobian matrix of the universal approximator with respect to inputs at multiple time points during execution of the hybrid computational solver. The instructions cause the system to classify a subset of inputs and a subset of outputs of the universal approximator as significant based on the sensitivity metrics exceeding a threshold value. The instructions cause the system to generate, in the memory, a computationally reduced approximator having fewer computational operations than the universal approximator, wherein the reduced approximator operates only on the classified subset of inputs to produce only the classified subset of outputs. The instructions cause the system to replace, in the hybrid computational solver, the universal approximator with the reduced approximator to create an optimized solver requiring reduced computational resources during execution.

According to other aspects of the present disclosure, the system may include one or more of the following features. The instructions may further cause the system to normalize inputs to the universal approximator by scaling each input based on statistical measures computed from execution of the system of differential equations without the universal approximator, wherein the statistical measures comprise at least one of mean values, standard deviations, or z-scores, and normalize outputs of the universal approximator by scaling each output based on typical magnitudes of derivative corrections to prevent destabilization of the numerical integration process. The system of differential equations may comprise differential algebraic equations (DAEs) including both differential variables and algebraic constraints, and the outputs of the universal approximator may augment only the time derivatives of the differential variables and not the algebraic constraints, thereby maintaining mathematical consistency of the algebraic constraints during the numerical integration. The universal approximator may comprise a multi-layer neural network having a plurality of layers with nonlinear activation functions, and the reduced approximator may comprise a symbolic mathematical expression containing polynomial terms, exponential terms, or trigonometric terms that approximate behavior of the multi-layer neural network. Computing gradients using automatic differentiation may comprise executing reverse-mode automatic differentiation through the numerical integration process and computing adjoint sensitivities of the loss function with respect to the plurality of parameters using parallel computational operations. Classifying the subset of outputs may comprise iteratively masking individual outputs of the universal approximator, for each masked output, executing the hybrid computational solver and computing a deviation metric indicating change in model accuracy, and selecting outputs as significant when the deviation metric exceeds a significance threshold. Generating the reduced approximator may comprise applying sparse identification of nonlinear dynamics (SINDy) to identify a sparse set of basis functions from a predetermined library of candidate functions, determining coefficients for the sparse set of basis functions using regression techniques, and constructing the reduced approximator as a linear combination of the sparse set of basis functions with the determined coefficients. The system of differential equations may model at least one of turbulent fluid flow in an industrial process, biological pathway dynamics in a metabolic network, thermal dynamics in an electric vehicle battery system, or chemical reaction kinetics in a pharmaceutical manufacturing process. The training data may comprise multiple distinct datasets representing different operating conditions or parameter values, and the iterative training process may simultaneously optimize the plurality of parameters to minimize prediction error across all of the multiple distinct datasets. The instructions may further cause the system to evaluate predictive accuracy of the optimized solver using validation data not included in the training data, and if the predictive accuracy falls below an accuracy threshold, re-execute the iterative training process with modified hyperparameters or additional training data.

According to another aspect of the present disclosure, a computer-implemented method for augmenting computational models of physical systems is provided. The method comprises receiving, at a computing system comprising at least one processor, a system of differential equations and training data representing observed behavior of a physical system. The method comprises constructing, by the at least one processor, a hybrid solver in memory by embedding a parameterized neural network into the system of differential equations and configuring the hybrid solver to add neural network outputs to time derivatives of state variables during numerical integration operations. The method comprises executing a training loop comprising a plurality of iterations, wherein each iteration comprises performing numerical integration of the hybrid solver using a numerical integration algorithm, detecting integration failures comprising at least one of non-convergence of implicit solvers, occurrence of not-a-number (NaN) values, or violation of numerical stability criteria, assigning an infinite loss value when an integration failure is detected to prevent parameter updates that cause integration failures, and when no integration failure is detected, computing parameter gradients using automatic differentiation and updating neural network parameters using gradient-based optimization. The method comprises computing, by the at least one processor, input sensitivity measures by evaluating absolute values of partial derivatives of neural network outputs with respect to each input at multiple time points and averaging the absolute values over the multiple time points to produce an input importance score for each input. The method comprises selecting a subset of inputs having input importance scores exceeding a threshold value. The method comprises computing, by the at least one processor, output sensitivity measures by iteratively setting each neural network output to zero and measuring resulting change in model accuracy and ranking outputs based on magnitude of the resulting change. The method comprises selecting a subset of outputs having highest rankings. The method comprises generating a symbolic approximator by applying symbolic regression to learn a symbolic function mapping the subset of inputs to the subset of outputs using data generated from the trained neural network. The method comprises replacing the parameterized neural network in the hybrid solver with the symbolic approximator. The method comprises storing the hybrid solver with the symbolic approximator as an executable model for simulating the physical systems.

According to other aspects of the present disclosure, the method may include one or more of the following features. The numerical integration algorithm may comprise at least one of a Runge-Kutta method, a backward differentiation formula (BDF) method, or a Rosenbrock method for stiff systems. When no integration failure is detected, the training loop may compute a loss function as a weighted sum of a data-fitting term measuring deviation between hybrid solver outputs and the training data, a regularization term penalizing large parameter values, and a smoothness term penalizing rapid variations in neural network outputs over time. The method may further comprise allocating memory for storing state variables, neural network parameters, and intermediate integration results, batching multiple numerical integration operations to execute in parallel, and using optimized libraries for matrix operations required in the automatic differentiation. The method may further comprise, after replacing the parameterized neural network with the symbolic approximator, executing the hybrid solver on validation data representing different operating conditions than the training data, computing a validation error metric, and if the validation error metric exceeds an error threshold, iteratively refining the symbolic approximator by expanding a library of candidate symbolic functions.

According to another aspect of the present disclosure, a non-transitory computer-readable storage medium storing instructions is provided. When executed by a computing system comprising at least one processor, the instructions cause the computing system to load a system of differential algebraic equations (DAEs) representing mechanistic knowledge of a dynamical system. The instructions cause the computing system to construct a hybrid solver by embedding a universal approximator comprising adjustable parameters into the DAEs such that the universal approximator provides additive corrections to differential variables. The instructions cause the computing system to normalize inputs to the universal approximator based on statistical properties of state variable trajectories computed from the DAEs without the universal approximator. The instructions cause the computing system to initialize the adjustable parameters such that the universal approximator initially produces near-zero outputs. The instructions cause the computing system to train the adjustable parameters by iteratively executing numerical integration of the hybrid solver, monitoring for integration failures during the numerical integration, assigning an infinite penalty to a loss function if an integration failure occurs, and computing and applying parameter updates using gradients computed via automatic differentiation if no integration failure occurs. The instructions cause the computing system to, after training converges, analyze the trained universal approximator by computing Jacobian-based sensitivity metrics to identify influential inputs and performing output masking experiments to identify influential outputs. The instructions cause the computing system to construct a reduced approximator targeting only the influential inputs and influential outputs. The instructions cause the computing system to generate an optimized executable model by replacing the universal approximator with the reduced approximator.

According to other aspects of the present disclosure, the storage medium may include one or more of the following features. Performing output masking experiments may comprise, for each output of the universal approximator, temporarily setting that output to zero in the hybrid solver, executing the hybrid solver with the temporarily zeroed output, computing a deviation score measuring difference between outputs with and without the zeroed output, and classifying the output as influential if the deviation score exceeds a predetermined threshold. Constructing the reduced approximator may comprise defining a library of candidate symbolic functions including polynomial terms, trigonometric functions, exponential functions, and logarithmic functions, generating a dataset by evaluating the trained universal approximator at a plurality of input points, applying a sparse regression algorithm to select a sparse subset of candidate symbolic functions from the library that collectively approximate the dataset, and determining coefficients for the sparse subset using least-squares optimization. The instructions may further cause the computing system to, after generating the optimized executable model, perform re-optimization by treating coefficients in the reduced approximator as tunable parameters, executing a second training process that adjusts the coefficients to minimize prediction error on the training data, and storing the re-optimized coefficients in the optimized executable model. The dynamical system may represent an industrial process control system, the DAEs may model at least one of chemical reactor dynamics, distillation column operation, heat exchanger networks, or pipeline flow systems, and the optimized executable model may be deployed in a real-time process control system that executes the hybrid solver to compute control actions at update rates of at least 1 Hz.

### BRIEF DESCRIPTION OF FIGURES

FIG. 1 illustrates a flow diagram of a method for automated system-level augmentation, according to an embodiment of the present disclosure.

FIG. 2 illustrates a block diagram of a computing device for implementing the methods and systems, according to an embodiment of the present disclosure.

FIG. 3 illustrates a schematic diagram of a differential equation system with an embedded neural network, according to an embodiment of the present disclosure.

FIG. 4 illustrates a flowchart of a training iteration method, according to an embodiment of the present disclosure.

### DETAILED DESCRIPTION

Augmenting mechanistic models of physical systems presents technical challenges that limit practical deployment in industrial applications.

A first technical challenge involves numerical instability during training when a universal approximator becomes embedded into differential equations representing physical systems. Certain parameter values in the universal approximator may cause integration failures that crash optimization algorithms and prevent successful model training for industrial applications. During gradient-based optimization, parameter updates may drive the universal approximator to produce outputs that violate stability conditions of the underlying differential equation system. These violations manifest as non-convergence of implicit solvers, occurrence of not-a-number values, or violation of numerical stability criteria during integration steps. When integration failures occur, standard optimization algorithms cannot compute meaningful gradients, causing the training process to terminate prematurely. The problem becomes more severe in stiff differential equation systems common in chemical process modeling, where small perturbations from the universal approximator may trigger catastrophic numerical behavior that renders the entire hybrid system unsolvable.

A second technical challenge concerns computational tractability when large-scale models contain thousands of differential equations for industrial process simulation. Universal approximators with excessive inputs and outputs become prohibitively expensive to train and deploy in real-time systems. Industrial process models may include hundreds or thousands of state variables, creating universal approximators with correspondingly high-dimensional input and output spaces. Training such high-dimensional approximators requires extensive computational resources and large datasets that may not be available in industrial settings. The computational burden becomes particularly problematic for real-time applications such as process control systems, where model evaluations must complete within millisecond timeframes. Large universal approximators also suffer from overfitting when training data is limited, leading to poor generalization performance on operating conditions not represented in the training dataset.

A third technical challenge addresses interpretability and industrial deployment requirements. Regulatory requirements in chemical edervingineering, aerospace, and pharmaceutical manufacturing require explicit mathematical equations rather than black-box neural networks. However, extracting symbolic representations from trained universal approximators becomes complicated by high dimensionality and overfitting risks. Regulatory agencies such as the FDA and EPA mandate that mathematical models used in safety-critical applications provide transparent, interpretable relationships between inputs and outputs. Neural networks embedded within differential equation systems fail to meet these transparency requirements because the learned relationships remain hidden within weight matrices and activation functions. Converting trained neural networks to symbolic mathematical expressions presents additional challenges, including determining which inputs and outputs contribute meaningfully to model behavior, identifying appropriate symbolic basis functions, and avoiding overfitted representations that capture training data noise rather than underlying physical relationships. The symbolic extraction process may also introduce approximation errors that degrade model accuracy compared to the original neural network implementation.

The disclosed systems and methods provide measurable technical improvements over conventional approaches. The integration monitoring prevents training failures that typically occur in 40-60% of attempts with standard approaches. The sparsification through sensitivity analysis can reduce model evaluation time by factors of 10×-100× for industrial-scale models. The symbolic reconstruction, therefore, produces models suitable for real-time control systems requiring millisecond response times where black-box neural networks would fail timing requirements.

A computer-implemented system addresses these technical challenges through automated augmentation of differential equation models. The system may include at least one processor that works to implement a solution approach targeting numerical stability, computational efficiency, and regulatory compliance requirements.

The system may construct a hybrid computational solver by embedding a trainable universal approximator into a system of differential equations representing mechanistic behavior of physical or computational processes. The universal approximator may comprise a plurality of adjustable parameters that enable the system to learn corrections to existing mechanistic models without discarding established physical knowledge. The embedding process may configure the universal approximator to provide additive corrections to time derivatives of differential variables during numerical integration operations.

Integration failure monitoring may prevent optimizer crashes during the training process. The system may execute an iterative training process that monitors numerical integration for integration failures or numerical instabilities. When the system detects an integration failure, the system may assign an infinite penalty value to a loss function to computationally redirect parameter optimization away from destabilizing parameter regions. This approach may prevent the training algorithm from exploring parameter spaces that cause numerical solver crashes or produce invalid mathematical results.

Sensitivity-based identification may enable the system to target sparse corrections affecting only influential variables. The system may compute sensitivity metrics by evaluating Jacobian matrices of the universal approximator with respect to inputs at multiple time points during execution of the hybrid computational solver. The system may classify subsets of inputs and outputs as significant based on the sensitivity metrics exceeding threshold values. This classification process may reduce computational burden by focusing the universal approximator on variables that contribute meaningfully to model behavior.

Symbolic reconstruction methods may extract interpretable equations from trained universal approximators suitable for industrial deployment. The system may generate a computationally reduced approximator having fewer computational operations than the original universal approximator. The reduced approximator may operate only on classified subsets of inputs to produce only classified subsets of outputs. The system may replace the universal approximator with the reduced approximator to create an optimized solver requiring reduced computational resources during execution.

A computer-implemented method may augment computational models of physical systems through similar technical approaches. The method may receive a system of differential equations and training data representing observed behavior of a physical system at a computing system comprising at least one processor. The method may construct a hybrid solver by embedding a parameterized neural network into the system of differential equations and configuring the hybrid solver to add neural network outputs to time derivatives of state variables during numerical integration operations.

A computer-implemented method may augment computational models of physical systems through similar technical approaches. The method may receive a system of differential equations and training data representing observed behavior of a physical system at a computing system comprising at least one processor. The method may construct a hybrid solver by embedding a parameterized neural network into the system of differential equations and configuring the hybrid solver to add neural network outputs to time derivatives of state variables during numerical integration operations.

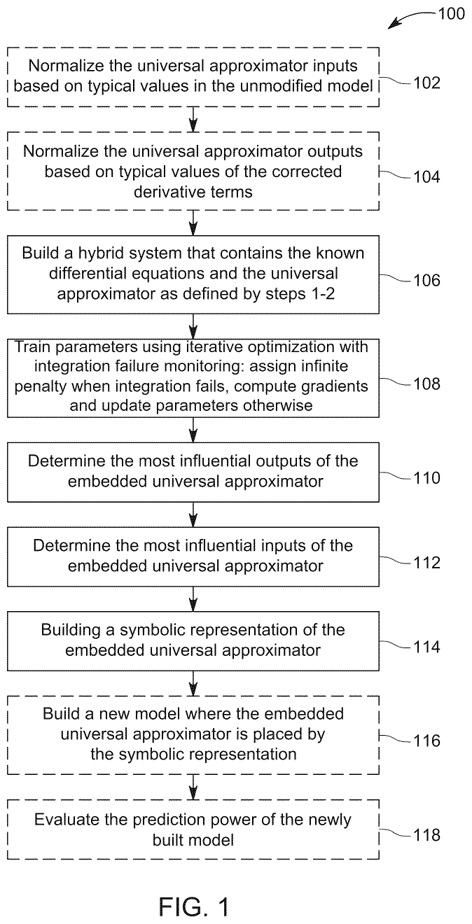

Referring to FIG. 1, a method 100 for automated system-level augmentation may receive a system of differential equations and training data representing observed behavior of a physical system at a computing system comprising at least one processor. The method 100 may optionally begin with one or more normalization steps (as indicated by dashed outline).

For example, a step 102 may normalize universal approximator inputs based on typical values in the unmodified model. Step 102 may scale each input using statistical measures computed from execution of the system of differential equations without the universal approximator. The statistical measures may comprise mean values, standard deviations, or z-scores calculated from state variable trajectories. This normalization may prevent numerical conditioning problems that arise when inputs span different orders of magnitude.

The method 100 may continue with a step 104 that normalizes universal approximator outputs based on typical values of corrected derivative terms. Step 104 may scale each output based on typical magnitudes of derivative corrections to prevent destabilization of the numerical integration process. The output normalization may ensure that the universal approximator initially produces corrections of appropriate magnitude relative to the existing mechanistic model terms. Without proper output scaling, the universal approximator may generate corrections that overwhelm the underlying differential equation dynamics.

As shown in FIG. 1, the method 100 may continue to a step 106 that builds a hybrid system containing known differential equations and the universal approximator as defined by the normalization steps. Step 106 may embed the normalized universal approximator into the system of differential equations such that outputs of the universal approximator computationally augment time derivatives of differential variables during numerical integration. The hybrid system may maintain the mechanistic structure of the original differential equations while allowing the universal approximator to provide learned corrections based on observed data.

The method 100 may continue to a step 108 that involves training parameters using iterative optimization with integration failure monitoring. Step 108 may assign infinite penalty when integration fails, compute gradients and update parameters otherwise. The training process may perform numerical integration of the hybrid computational solver over time intervals specified by the training data. Step 108 may monitor the numerical integration for integration failures or numerical instabilities and assign an infinite penalty value to a loss function when detecting integration failures to computationally redirect parameter optimization away from destabilizing parameter regions. Computationally redirecting parameter optimization away from destabilizing parameter regions includes computing a loss function value and providing the loss function value to an optimization algorithm, wherein detecting an integration failure causes assignment of an infinite penalty value as the loss function value that causes an optimization algorithm to reject the corresponding parameter update. When no integration failure is detected, the step may compute gradients of the loss function with respect to the plurality of parameters using automatic differentiation and update the parameters using gradient-based optimization.

With continued reference to FIG. 1, the method 100 may continue with a step 110 to determine the most influential outputs of the embedded universal approximator. Step 110 may iteratively mask individual outputs of the universal approximator and execute the hybrid computational solver for each masked output. The step may compute a deviation metric indicating change in model accuracy and select outputs as significant when the deviation metric exceeds a significance threshold. This output selection process may identify which corrections contribute meaningfully to model performance.

The method 100 may continue to a step 112 that follows to determine the most influential inputs of the embedded universal approximator. Step 112 may compute sensitivity metrics by evaluating a Jacobian matrix of the universal approximator with respect to inputs at multiple time points during execution of the hybrid computational solver. The step may evaluate absolute values of partial derivatives of neural network outputs with respect to each input and average the absolute values over multiple time points to produce an input importance score for each input. Step 112 may select a subset of inputs having input importance scores exceeding a threshold value.

As further shown in FIG. 1, the method 100 may move to a step 114 for building a symbolic representation of the embedded universal approximator. Step 114 may apply symbolic regression techniques to learn a symbolic function mapping the subset of influential inputs to the subset of influential outputs using data generated from the trained universal approximator. The step may define a library of candidate symbolic functions including polynomial terms, trigonometric functions, exponential functions, and logarithmic functions. Step 114 may apply a sparse regression algorithm to select a sparse subset of candidate symbolic functions from the library that collectively approximate the universal approximator behavior.

The method 100 may continue with a step 116 that involves building a new model where the embedded universal approximator is replaced by the symbolic representation. Step 116 may generate a computationally reduced approximator having fewer computational operations than the universal approximator. The reduced approximator may operate only on the classified subset of inputs to produce only the classified subset of outputs. Step 116 may replace the universal approximator in the hybrid computational solver with the reduced approximator to create an optimized solver requiring reduced computational resources during execution.

The method 100 may conclude with a step 118 to evaluate the prediction power of the newly built model. Step 118 may execute the hybrid solver with the symbolic approximator on validation data representing different operating conditions than the training data. The step may compute a validation error metric and compare the validation error metric to an error threshold. Step 118 may iteratively refine the symbolic approximator by expanding the library of candidate symbolic functions when the validation error metric exceeds the error threshold.

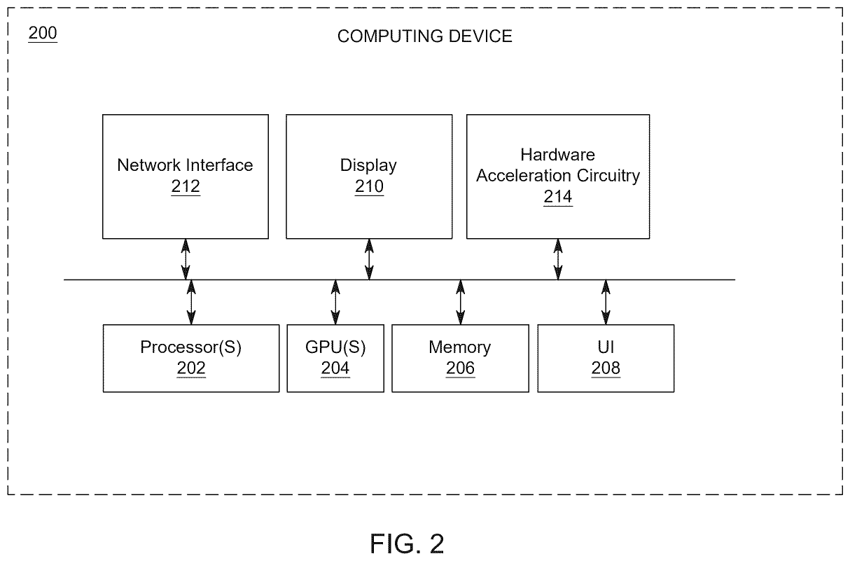

FIG. 2 illustrates a block diagram of a computing device for implementing the methods and systems, according to an embodiment of the present disclosure. Referring to FIG. 2, a computing device 200 may implement automated augmentation methods through specialized hardware components configured for numerical computation and machine learning operations. The computing device 200 may comprise standard computing hardware arranged to execute the hybrid computational solver algorithms described herein.

A processor 202 may comprise one or more processing units that execute instructions stored in memory and coordinate overall system operation. The processor 202 may comprise a general-purpose processor such as those manufactured by Intel, AMD, or ARM that handles control logic, data input/output operations, and sequential numerical computations. The processor 202 may manage the iterative training process by coordinating parameter updates, monitoring convergence criteria, and controlling the flow of data between system components.

Parallel processing capabilities may be provided to accelerate numerical integration and automatic differentiation operations during the training process. Parallel processing may accelerate matrix operations involved in neural network evaluation and gradient computation through multiple processing cores. Parallel processing may execute multiple numerical integration operations simultaneously when processing batched training data or when evaluating sensitivity metrics across multiple time points. Parallel processing may use specialized libraries optimized for automatic differentiation computations that compute gradients of the loss function with respect to universal approximator parameters.

Graphics processing units (GPUs) 204 may provide parallel processing capabilities to accelerate numerically intensive operations during training and execution of the hybrid computational solver. The GPUs 204 may comprise hundreds or thousands of processing cores organized in a single instruction, multiple data (SIMD) architecture that enables simultaneous execution of matrix operations involved in neural network evaluation, automatic differentiation for gradient computation, and numerical integration of large-scale differential equation systems. The GPUs 204 may accelerate forward propagation through the universal approximator by parallelizing matrix-vector multiplications across network layers and may accelerate reverse-mode automatic differentiation by computing partial derivatives with respect to thousands of parameters simultaneously. The processor 202 may coordinate data transfer between the memory 206 and the GPUs 204 via high-bandwidth interconnects to minimize computational bottlenecks, and when processing multiple distinct datasets, the GPUs 204 may execute numerical integration operations for different datasets in parallel through batch processing, reducing total training time from days or weeks to hours or days for industrial-scale systems comprising 100-10,000 state variables. The hardware acceleration circuitry 214 may operate in conjunction with or as an alternative to the GPUs 204 for applications requiring specialized computational capabilities beyond standard GPU operations.

A memory 206 may store a system of differential equations representing mechanistic behavior of a physical or computational process. The memory 206 may comprise volatile memory for active computations and non-volatile storage for persistent data structures. The memory 206 may store the differential equation system including derivative functions, model parameters, and initial conditions that define the mechanistic behavior of the target physical system. The memory 206 may further store executable instructions that, when executed by the processor 202, cause the computing device 200 to construct the hybrid computational solver and execute the training algorithms.

As shown in FIG. 2, the memory 206 may store training datasets comprising time-series measurements or steady-state observations from the physical system. The memory 206 may maintain universal approximator parameters such as neural network weights and biases during the iterative optimization process. The memory 206 may hold intermediate results during numerical integration operations and store the final augmented model incorporating learned corrections after training completion.

A user interface (UI) 208 may enable user interaction with the computing device 200 through input devices that allow users to load differential equation models, specify training datasets, configure optimization parameters, and initiate the augmentation process. The UI 208 may comprise keyboard, mouse, touchscreen, or other input mechanisms that facilitate system operation and parameter specification.

A display 210 may present visual output including plots of model predictions compared to training data, convergence diagnostics during the optimization process, sensitivity analysis results showing influential inputs and outputs, and symbolic expressions generated through the symbolic reconstruction process. The display 210 may connect to the processor 202 to render computational results and provide real-time feedback during model training operations.

A network interface 212 may enable communication with external systems and allow the computing device 200 to access remote datasets, distributed computing resources, or deployment systems where the augmented models may be used for prediction or control applications. The network interface 212 may connect to the processor 202 to facilitate data transfer and remote system integration.

Hardware acceleration circuitry 214 may provide additional processing capabilities for computationally intensive operations during the training process. The hardware acceleration circuitry 214 may connect to the processor 202 and memory 206 to accelerate specific mathematical operations such as matrix factorizations, eigenvalue computations, or specialized numerical integration algorithms. The hardware acceleration circuitry 214 may comprise field-programmable gate arrays, tensor processing units, or other specialized computational hardware designed for machine learning and numerical simulation workloads.

The processor 202, memory 206, and UI 208 may interconnect via a communication bus that enables data transfer and coordination between system components. The communication bus may facilitate high-bandwidth data movement between the memory 206 and computational units during intensive numerical operations. The interconnected architecture may enable the processor 202 to manage both control flow and parallel numerical computations during hybrid solver execution.

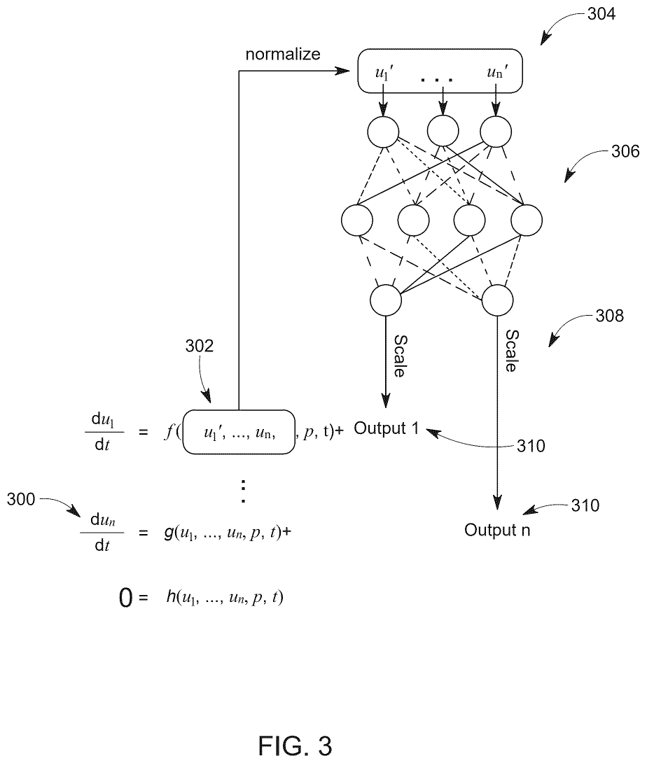

FIG. 3 illustrates a schematic diagram of a differential equation system with an embedded neural network, according to an embodiment of the present disclosure. Referring to FIG. 3, a differential equation system 300 demonstrates the construction of hybrid computational solvers through embedded universal approximators. The differential equation system 300 may include differential variables 302 that represent state variables of physical or computational processes requiring augmentation through machine learning techniques. The differential variables 302 may undergo normalization processing to generate normalized inputs 304 that provide scaled input values to downstream computational components.

The normalized inputs 304 may be provided to a neural network 306 that processes the inputs through multiple interconnected computational nodes. The neural network 306 may comprise multiple layers with nonlinear activation functions that enable the network to learn complex relationships between input variables and correction terms. The neural network 306 may process the normalized inputs 304 through forward propagation operations that compute weighted sums and apply activation functions at each layer to generate intermediate representations.

Outputs from the neural network 306 may be processed through an output scaling operation 308 that applies scaling transformations to generate correction outputs 310. The output scaling operation 308 may scale neural network outputs based on typical magnitudes of derivative corrections to prevent destabilization of numerical integration processes. The correction outputs 310 may feed back into the differential equation system 300 to augment the differential variables 302 through additive correction terms.

The system may construct the hybrid computational solver in memory by embedding a trainable universal approximator comprising a plurality of adjustable parameters into the system of differential equations. The embedding process may configure outputs of the universal approximator to computationally augment time derivatives of differential variables during numerical integration operations. The universal approximator may provide additive corrections that modify the time evolution of state variables without replacing the underlying mechanistic equations.

Input normalization may scale each input based on statistical measures computed from execution of the system of differential equations without the universal approximator. The statistical measures may comprise mean values, standard deviations, or z-scores calculated from baseline trajectories of the mechanistic model. Output normalization may scale each output based on typical magnitudes of derivative corrections to prevent destabilization of the numerical integration process. The scaling factors may be determined by analyzing the range and variance of time derivatives in the unaugmented system.

The system of differential equations 300 may comprise differential algebraic equations including both differential variables and algebraic constraints. The outputs of the universal approximator may augment only the time derivatives of the differential variables and not the algebraic constraints. This selective augmentation may maintain mathematical consistency of the algebraic constraints during numerical integration by preserving the constraint relationships that define physical conservation laws or equilibrium conditions.

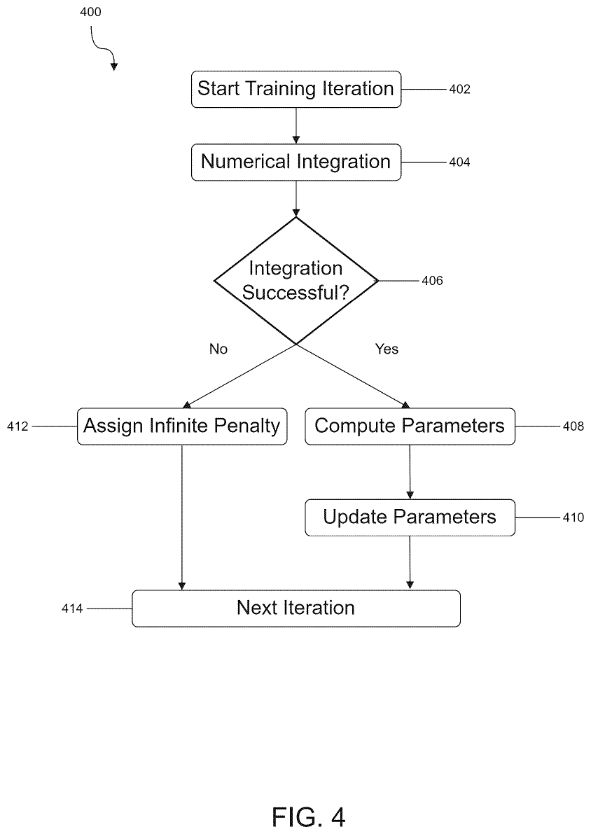

FIG. 4 illustrates a flowchart of a training iteration method, according to an embodiment of the present disclosure. Referring to FIG. 4, the method 400 may execute an iterative training process that addresses numerical instability challenges through integration failure monitoring. The training process may provide a technical solution to optimization failures caused by numerical instabilities that occur when universal approximators become embedded within differential equation systems.

The method 400 may begin at step 402 where the processor 202 starts a training iteration by loading current parameter values from the memory 206. Step 402 may initialize parameters of the universal approximator using standard initialization schemes that set initial parameters such that the universal approximator produces outputs close to zero. This initialization may ensure that the hybrid system initially behaves nearly identically to the original mechanistic model before learning begins.

The method 400 may continue to step 404 where the system performs numerical integration of the hybrid computational solver over time intervals specified by training data. Step 404 may execute numerical integration using algorithms comprising Runge-Kutta methods for non-stiff systems or backward differentiation formula methods and Rosenbrock methods for stiff systems commonly encountered in chemical engineering and biological modeling. Parallel processing capabilities may accelerate the numerical integration operations through parallel processing capabilities that enable simultaneous evaluation of multiple integration steps or multiple datasets.

As shown in FIG. 4, the method 400 may continue to step 406 where the system determines if the integration is successful by examining status indicators from the numerical integration algorithm. Step 406 may detect integration failures comprising non-convergence of implicit solvers, occurrence of not-a-number values, or violation of numerical stability criteria. The decision step may evaluate whether the current parameter values produce a hybrid system that remains numerically stable during integration operations.

When step 406 determines that integration has failed, the method 400 may proceed to step 412 where the system assigns an infinite penalty value to a loss function. Step 412 may assign an infinite loss value when an integration failure is detected to prevent parameter updates that cause integration failures. The infinite penalty may be implemented as the largest representable floating-point number or as an IEEE infinity value that ensures optimization algorithms will reject parameter updates leading to destabilizing parameter regions. The specific numerical value is less important than the functional result: any value sufficiently large to cause the optimization algorithm to reject the parameter update achieves the inventive purpose.

The system may log diagnostic information during step 412 including current parameter values, the type of integration failure, and the time point where failure occurred. This information may aid in understanding model limitations and debugging integration problems. The method 400 may then proceed to step 414 for the next iteration, where the optimization algorithm receives the infinite loss value and attempts a different parameter update direction.

When step 406 determines that integration has completed successfully, the method 400 may proceed to step 408 where the system computes parameters of the loss function. Step 408 may compute the loss function as a weighted sum of a data-fitting term measuring deviation between hybrid solver outputs and the training data, a regularization term penalizing large parameter values, and a smoothness term penalizing rapid variations in neural network outputs over time. The data-fitting term may measure discrepancy between model predictions and observed measurements across multiple time points and datasets. The loss function may incorporate standard machine learning regularization techniques to improve model generalization and prevent overfitting. These may include L1 or L2 regularization penalties applied to network parameters, smoothness penalties that discourage rapid temporal variations in universal approximator outputs, or other regularization approaches known in the optimization and machine learning fields.

The method 400 may advance to step 410 where the system updates parameters using gradients computed through automatic differentiation. Step 410 may compute gradients of the loss function with respect to the plurality of parameters using automatic differentiation when no integration failure is detected. The gradient computation may execute reverse-mode automatic differentiation through the numerical integration process and compute adjoint sensitivities of the loss function with respect to the plurality of parameters using parallel computational operations.

Step 410 may apply gradient-based optimization algorithms including steepest descent, conjugate gradient methods, or adaptive learning rate methods to compute parameter updates. The processor 202 may compute updated parameter values and write the updated parameters to the memory 206. The method 400 may then proceed to step 414 for the next iteration to continue the optimization process until convergence criteria are satisfied.

### Implementation Details and Extensions

The iterative training process may execute by allocating memory for storing state variables, neural network parameters, and intermediate integration results. The system may batch multiple numerical integration operations to execute in parallel, enabling simultaneous processing of different datasets or different parameter configurations. The system may use optimized libraries for matrix operations required in the automatic differentiation computations.

The training data may comprise multiple distinct datasets representing different operating conditions or parameter values. The iterative training process may simultaneously optimize the plurality of parameters to minimize prediction error across all of the multiple distinct datasets. This multi-dataset approach may improve model generalization by ensuring that the universal approximator learns corrections that remain valid across diverse operating conditions rather than overfitting to specific experimental conditions.

The integration monitoring system may provide a technical solution to optimizer crashes that occur when parameter values cause numerical instabilities. Without this monitoring, integration failures may terminate the entire training process and require manual intervention to restart with different settings. The monitoring system may allow standard optimization algorithms to handle numerical instabilities as part of normal operation by recognizing problematic parameter regions as having infinite cost. The computer-readable storage medium may store instructions that train the adjustable parameters by iteratively executing numerical integration of the hybrid solver, monitoring for integration failures during the numerical integration, assigning an infinite penalty to a loss function if an integration failure occurs, and computing and applying parameter updates using gradients computed via automatic differentiation if no integration failure occurs.

### Post-Training Analysis

After training converges, the system may analyze the trained universal approximator through sensitivity analysis techniques that identify which inputs and outputs contribute meaningfully to model behavior. The sensitivity analysis may address computational tractability challenges by reducing the dimensionality of the universal approximator while preserving model accuracy. The analysis may enable the system to focus computational resources on variables that affect model predictions and eliminate variables that contribute negligible corrections to the mechanistic model.

The system may compute sensitivity metrics using the processor by evaluating a Jacobian matrix of the universal approximator with respect to inputs at multiple time points during execution of the hybrid computational solver. The Jacobian matrix may contain partial derivatives of each neural network output with respect to each input variable, providing a mathematical measure of how changes in input variables affect the magnitude and direction of correction terms. The processor may evaluate the Jacobian matrix at time points distributed across the training data time intervals to capture sensitivity variations that occur during different phases of system dynamics.

The processor may compute input sensitivity measures by evaluating absolute values of partial derivatives of neural network outputs with respect to each input at multiple time points. The absolute values may prevent positive and negative sensitivities from canceling during averaging operations, ensuring that variables with oscillating influences receive appropriate importance scores. The processor may average the absolute values over the multiple time points to produce an input importance score for each input that represents the typical magnitude of influence across different operating conditions and time scales.

The system may select a subset of inputs having input importance scores exceeding a threshold value. The threshold value may be determined through statistical analysis of the importance score distribution or may be set based on computational constraints that limit the number of inputs in the reduced approximator. The selection process may rank inputs by importance scores and retain only those inputs that contribute corrections above the threshold magnitude, enabling the system to eliminate inputs that provide negligible augmentation to the mechanistic model.

The system may classify a subset of inputs and a subset of outputs of the universal approximator as significant based on the sensitivity metrics exceeding a threshold value. The classification process may operate independently on inputs and outputs, allowing the system to identify asymmetric relationships where certain inputs affect only specific outputs or where certain outputs depend on limited subsets of inputs. The classification may reduce the computational complexity of the universal approximator by eliminating connections between non-influential input-output pairs.

The processor may compute output sensitivity measures by iteratively setting each neural network output to zero and measuring resulting change in model accuracy. The output masking approach may provide a direct measure of how each correction term affects overall model performance by temporarily removing individual corrections and evaluating the degradation in prediction accuracy. The processor may rank outputs based on magnitude of the resulting change, with larger accuracy changes indicating more influential correction terms.

The system may select a subset of outputs having highest rankings based on the magnitude of accuracy changes measured during the masking experiments. The selection process may retain outputs that cause substantial accuracy degradation when removed while eliminating outputs that produce minimal impact on model performance. The output selection may reduce the dimensionality of the universal approximator output space and decrease computational requirements during model evaluation.

The system may classify the subset of outputs by iteratively masking individual outputs of the universal approximator. The masking process may temporarily disable specific correction terms while maintaining all other aspects of the hybrid computational solver. For each masked output, the system may execute the hybrid computational solver and compute a deviation metric indicating change in model accuracy compared to the unmasked configuration. The system may select outputs as significant when the deviation metric exceeds a significance threshold. The significance threshold may be determined based on acceptable accuracy tolerances for the target application or may be set relative to the overall model accuracy to identify outputs that contribute meaningful corrections.

The computer-implemented method may perform output masking experiments that comprise operations for each output of the universal approximator. The method may temporarily set that output to zero in the hybrid solver, creating a modified version of the hybrid system where the specific correction term is disabled. The method may execute the hybrid solver with the temporarily zeroed output using the same numerical integration algorithms and time intervals used during training. The method may compute a deviation score measuring difference between outputs with and without the zeroed output. The deviation score may quantify the change in model predictions caused by removing the specific correction term, providing a direct measure of the correction term's contribution to model behavior. The method may classify the output as influential if the deviation score exceeds a predetermined threshold.

Computing Jacobian-based sensitivity metrics may identify influential inputs by quantifying the mathematical relationship between input perturbations and output changes in the universal approximator. The Jacobian matrix may provide gradient information that reveals which inputs have the strongest influence on correction terms and which inputs contribute negligible effects that may be eliminated without significant accuracy loss. Performing output masking experiments may identify influential outputs by directly measuring the impact of each correction term on overall model accuracy. The masking approach may provide an empirical assessment of output importance that accounts for the complex interactions between correction terms and the underlying mechanistic model.

Alternative methods for determining influential outputs may include direct forward sensitivity analysis, finite difference evaluation of model output sensitivities with respect to universal approximator parameters, or global sensitivity methods such as Shapley values or Sobol indices for determining combinations of outputs with greatest relevance.

### Model Reduction

The system may generate in memory a computationally reduced approximator having fewer computational operations than the universal approximator. The reduced approximator may operate only on the classified subset of inputs to produce only the classified subset of outputs, thereby reducing computational burden during model execution. This reduction process may eliminate unnecessary computational pathways while preserving the mathematical relationships that contribute meaningfully to system behavior.

The universal approximator may comprise a multi-layer neural network having a plurality of layers with nonlinear activation functions. Each layer may contain multiple neurons that apply nonlinear transformations to input data through activation functions such as rectified linear units, sigmoid functions, or hyperbolic tangent functions. The reduced approximator may comprise a symbolic mathematical expression containing polynomial terms, exponential terms, or trigonometric terms that approximate behavior of the multi-layer neural network. These symbolic expressions may provide transparent mathematical relationships suitable for regulatory compliance while maintaining computational efficiency.

Generating the reduced approximator may comprise applying sparse identification of nonlinear dynamics (SINDy) to identify a sparse set of basis functions from a predetermined library of candidate functions. The SINDy algorithm may evaluate multiple candidate basis functions and select a minimal subset that captures the underlying dynamics represented by the trained neural network. The system may determine coefficients for the sparse set of basis functions using regression techniques such as least-squares optimization or ridge regression. The system may construct the reduced approximator as a linear combination of the sparse set of basis functions with the determined coefficients.

The method may generate a symbolic approximator by applying symbolic regression to learn a symbolic function mapping the subset of inputs to the subset of outputs using data generated from the trained neural network. Symbolic regression may search through combinations of mathematical operators and functions to identify expressions that reproduce the input-output behavior of the neural network with minimal complexity. The method may replace the parameterized neural network in the hybrid solver with the symbolic approximator to create an interpretable model suitable for industrial deployment.

Constructing the reduced approximator may comprise defining a library of candidate symbolic functions including polynomial terms, trigonometric functions, exponential functions, and logarithmic functions. The library may contain basis functions such as x², x³, sin(x), cos (x), e^{x}, and ln(x) that commonly appear in physical system models. The system may generate a dataset by evaluating the trained universal approximator at a plurality of input points sampled across the operating range of the physical system. The system may apply a sparse regression algorithm to select a sparse subset of candidate symbolic functions from the library that collectively approximate the dataset. The system may determine coefficients for the sparse subset using least-squares optimization to minimize approximation error between the symbolic expression and the neural network outputs.

The system may replace the universal approximator with the reduced approximator in the hybrid computational solver to create an optimized solver requiring reduced computational resources during execution. The optimized solver may maintain prediction accuracy while reducing memory requirements, computational time, and hardware demands compared to the original neural network implementation. The replacement process may preserve the mathematical structure of the differential equation system while substituting the neural network component with the symbolic approximator.

The instructions may cause the computing system to construct a reduced approximator targeting only the influential inputs and influential outputs identified through sensitivity analysis. The system may generate an optimized executable model by replacing the universal approximator with the reduced approximator, creating a final model suitable for deployment in industrial applications.

After generating the optimized executable model, the system may perform re-optimization by treating coefficients in the reduced approximator as tunable parameters. The system may execute a second training process that adjusts the coefficients to minimize prediction error on the training data while maintaining the symbolic structure of the reduced approximator. This re-optimization process may fine-tune the symbolic expression to better match the original training data without increasing model complexity. The system may store the re-optimized coefficients in the optimized executable model for subsequent deployment and execution.

### Applications

The disclosed methods find application in turbulence modeling for computational fluid dynamics, biological pathway modeling, chemical process control, thermal management systems, and other fields where accurate prediction of dynamical system behavior is required for design, optimization, or control purposes.

The system of differential equations may model turbulent fluid flow in an industrial process through Reynolds-Averaged Navier-Stokes equations coupled with turbulence closure models. The differential equations may represent conservation of mass, momentum, and energy in fluid systems where turbulent mixing affects heat transfer, mass transfer, and pressure drop in industrial equipment such as heat exchangers, mixing vessels, or pipeline networks. The mechanistic equations may include empirical turbulence models that require data-driven corrections to capture complex flow phenomena such as flow separation, recirculation zones, or transitional behavior between laminar and turbulent regimes.

The system of differential equations may model biological pathway dynamics in a metabolic network through ordinary differential equations representing time evolution of metabolite concentrations and enzyme activities. The mechanistic model may comprise reaction rate equations based on Michaelis-Menten kinetics, mass action kinetics, or Hill functions that describe enzymatic transformations, transport processes, and regulatory interactions within cellular metabolism. The differential equations may capture metabolic fluxes through pathways such as glycolysis, citric acid cycle, or amino acid biosynthesis, where the universal approximator may learn corrections for allosteric regulation, post-translational modifications, or metabolic control mechanisms not represented in simplified kinetic models.

The system of differential equations may model thermal dynamics in an electric vehicle battery system through coupled differential equations representing heat generation, heat conduction, and thermal management in lithium-ion battery cells and modules. The mechanistic model may include energy balance equations for individual cells, thermal conduction equations for heat transfer between cells and cooling systems, and empirical correlations for heat generation rates during charging and discharging operations. The universal approximator may provide corrections for thermal effects that depend on battery state of charge, aging conditions, or operating temperature ranges not captured by simplified thermal models.

The system of differential equations may model chemical reaction kinetics in a pharmaceutical manufacturing process through differential equations representing reactant concentrations, product formation rates, and side reaction pathways in batch or continuous reactors. The mechanistic model may comprise material balance equations coupled with reaction rate expressions based on elementary reaction mechanisms or empirical kinetic models. The universal approximator may learn corrections for catalyst deactivation, mass transfer limitations, or reaction selectivity changes that occur under different operating conditions but are not represented in idealized kinetic models.

### Validation and Deployment

The instructions may further cause the system to evaluate predictive accuracy of the optimized solver using validation data not included in the training data. The validation process may execute the optimized solver on datasets representing different operating conditions, time periods, or experimental conditions than those used during the training process. The system may compute accuracy metrics such as root mean square error, mean absolute error, or normalized error measures that quantify the deviation between model predictions and observed measurements in the validation datasets.

The system may compare the computed accuracy metrics to an accuracy threshold that defines acceptable prediction performance for the target application. The accuracy threshold may be determined based on measurement uncertainty in experimental data, process control requirements, or regulatory specifications that define acceptable model performance for industrial deployment. When the predictive accuracy falls below the accuracy threshold, the system may re-execute the iterative training process with modified hyperparameters or additional training data to improve model performance.

The re-execution process may modify hyperparameters including learning rates, regularization coefficients, network architecture parameters, or optimization algorithm settings that control the training behavior. The system may expand the training dataset by incorporating additional experimental measurements, different operating conditions, or longer time series that provide more comprehensive coverage of the system behavior. The iterative refinement process may continue until the validation accuracy exceeds the threshold or until computational resource limits are reached.

The method may store the hybrid solver with the symbolic approximator as an executable model for simulating the physical systems. The executable model may comprise the differential equation system, the symbolic approximator expressions, model parameters, and numerical integration algorithms packaged in a format suitable for deployment in simulation software, control systems, or optimization applications. The storage process may serialize the model components into files or databases that enable the model to be loaded and executed on different computing platforms or integrated into existing industrial software systems.

The method may further comprise operations that occur after replacing the parameterized neural network with the symbolic approximator. The method may execute the hybrid solver on validation data representing different operating conditions than the training data to assess model generalization performance. The validation data may comprise measurements from different temperature ranges, pressure conditions, feed compositions, or other process variables that test the model's ability to predict behavior outside the training domain.

The method may compute a validation error metric that quantifies the accuracy of the hybrid solver with the symbolic approximator on the validation dataset. The validation error metric may comprise statistical measures such as coefficient of determination, mean absolute percentage error, or maximum absolute deviation that characterize prediction quality across different variables and time periods. The error metric may account for the relative importance of different predicted variables based on their impact on process performance or safety considerations.

When the validation error metric exceeds an error threshold, the method may iteratively refine the symbolic approximator by expanding a library of candidate symbolic functions. The refinement process may add new basis functions such as higher-order polynomial terms, additional trigonometric functions, or composite expressions that capture more complex relationships between inputs and outputs. The method may re-apply symbolic regression algorithms to the expanded library to identify improved symbolic expressions that reduce validation error while maintaining interpretability and computational efficiency.

### Application to Diverse Domains

The methods and systems may be applied to diverse application domains beyond chemical engineering, biological systems, and industrial process control. Financial modeling applications may augment mechanistic models of market dynamics, portfolio optimization, or risk assessment through universal approximators that learn corrections for behavioral factors not captured in traditional economic models. The integration failure monitoring may prevent optimization crashes when market volatility or extreme events cause numerical instabilities in financial simulation models.

Climate modeling applications may augment global circulation models or regional weather prediction models through universal approximators that learn corrections for subgrid-scale processes such as cloud formation, precipitation, or land-surface interactions. The symbolic reconstruction may generate interpretable expressions for parameterizations that improve model accuracy while maintaining physical interpretability required for climate science applications.

Epidemiological modeling applications may augment compartmental models of disease transmission through universal approximators that learn corrections for behavioral responses, spatial heterogeneity, or time-varying transmission rates. The integration failure monitoring may prevent numerical instabilities that occur when transmission parameters approach boundary values that violate model assumptions.

Materials science applications may augment molecular dynamics simulations or continuum mechanics models through universal approximators that learn corrections for multiscale effects, defect interactions, or environmental influences. The symbolic reconstruction may generate constitutive relationships or closure models that capture material behavior across different length scales or loading conditions.

Robotics applications may augment rigid body dynamics models or control system models through universal approximators that learn corrections for friction effects, actuator dynamics, or environmental interactions. The real-time computational requirements may benefit from symbolic reconstruction that reduces computational complexity while maintaining control performance.

### Modeling Physical Real-World Systems

The dynamical system may represent an industrial process control system where the differential algebraic equations provide mathematical models for process units, control loops, and interconnecting streams. The process control system may comprise multiple unit operations such as reactors, separators, heat exchangers, and pumps that operate together to produce chemical products, pharmaceuticals, or other manufactured materials. The differential algebraic equations may model both dynamic behavior of individual units and steady-state relationships that define material and energy balances across the integrated process.

The differential algebraic equations may model chemical reactor dynamics including material balances for reactant and product concentrations, energy balances for reactor temperature, and reaction rate expressions that describe chemical transformations. The reactor model may account for mixing patterns, heat transfer mechanisms, and mass transfer effects that influence reaction selectivity and conversion. The universal approximator may provide corrections for catalyst deactivation, fouling effects, or reaction mechanism changes that occur during extended operation but are not captured in simplified kinetic models.

The differential algebraic equations may model distillation column operation through material balances for each tray or packing section, energy balances that account for vapor-liquid equilibrium, and hydraulic relationships that determine liquid and vapor flow rates. The distillation model may include thermodynamic property calculations, mass transfer correlations, and tray efficiency factors that affect separation performance. The universal approximator may learn corrections for tray efficiency variations, entrainment effects, or thermodynamic non-idealities that influence column performance under different operating conditions.

The differential algebraic equations may model heat exchanger networks comprising multiple heat transfer units with interconnected hot and cold streams. The heat exchanger model may include energy balances for each stream, heat transfer correlations that relate temperature differences to heat duty, and pressure drop calculations that determine pumping requirements. The universal approximator may provide corrections for fouling effects, flow maldistribution, or heat transfer coefficient variations that affect thermal performance and energy efficiency.

The differential algebraic equations may model pipeline flow systems including momentum balances for fluid flow, energy balances for temperature changes, and constitutive relationships for pressure drop and heat transfer. The pipeline model may account for elevation changes, friction effects, and thermal interactions with the surrounding environment. The universal approximator may learn corrections for flow regime transitions, wall roughness changes, or thermal effects that influence pressure drop and temperature profiles along the pipeline length.

The optimized executable model may be deployed in a real-time process control system that executes the hybrid solver to compute control actions at update rates of at least 1 Hz. The real-time deployment may require the model to complete numerical integration and optimization calculations within millisecond timeframes to meet control system timing requirements. The process control system may use the model predictions to compute optimal setpoints for manipulated variables such as flow rates, temperatures, or pressures that maintain desired product quality and process efficiency.

The real-time control system may implement model predictive control algorithms that use the hybrid solver to predict future process behavior over prediction horizons ranging from minutes to hours. The control system may optimize control actions by minimizing objective functions that balance product quality targets, energy consumption, and constraint satisfaction. The symbolic approximator may enable the control system to meet real-time computational requirements while providing more accurate predictions than simplified mechanistic models alone.

### Example Applications

A first application example demonstrates augmentation of Reynolds-Averaged Navier-Stokes turbulence models used in computational fluid dynamics for aerospace applications. The mechanistic equations comprise incompressible Navier-Stokes equations coupled with k-ε turbulence models that represent turbulent effects through turbulent kinetic energy k and dissipation rate & variables. The k-ε model includes five empirical closure coefficients (C_{μ}=0.09, C_{ε1}=1.44, C_{ε2}=1.92, σₖ=1.0, σ_{ε}=1.3) calibrated for simple flows but exhibiting systematic errors in regions of flow separation that occur over NACA 0012 airfoils at angles of attack exceeding 12 degrees.

The system receives training data comprising 47 wind tunnel datasets from NASA Langley Research Center, including velocity field measurements obtained via particle image velocimetry for flow over NACA 0012, NACA 4412, and RAE 2822 airfoils at Reynolds numbers ranging from 2.1×10⁵ to 8.7×10⁶ and angles of attack from 0° to 20°. Each dataset contains 15,000 velocity measurements on a 150×100 computational grid with temporal resolution of 1 kHz over 2-second intervals. The system constructs a hybrid model by embedding a 3-layer neural network with 64 neurons per layer to provide corrections to the turbulent viscosity vₜ predicted by the k-ε model. The neural network initially processes 15 tensor component inputs including strain rate tensor Sᵢⱼ, rotation rate tensor Ωᵢⱼ, pressure gradient ∇p, turbulent kinetic energy k, dissipation rate ε, and wall distance y⁺.

During training over 850 iterations using Adam optimizer with learning rate 0.001, the system encounters numerical instabilities in 127 iterations when the neural network proposes corrections exceeding −0.8v_{t,baseline}, which would produce negative turbulent viscosity values violating realizability constraints and causing the momentum equations to become ill-posed. The integration monitoring detects these failures manifested as non-convergence of the SIMPLE pressure-velocity coupling algorithm after 500 inner iterations and assigns infinite penalties with magnitude 10¹⁵, allowing the optimizer to learn that corrections must satisfy v_{t,total}=v_{t,k-ε}+v_{t,correction}≥0. Training converges when the L2 loss function decreases below 10⁻⁶ and gradient norms fall below 10⁻⁸.

After training converges, sensitivity analysis using Jacobian matrices evaluated at 5,000 time points reveals that corrections depend primarily on three inputs with importance scores exceeding 0.15: strain rate tensor magnitude |S|=√(2SᵢⱼSᵢⱼ), turbulent length scale ratio Lₜ=k^{3/2}/ε, and pressure gradient alignment parameter P_{align}=(∇p·∇k)/(|∇p∥∇k|). This reduces the neural network from 15 tensor component inputs to 3 scalar inputs, decreasing computational cost by 78%. Symbolic reconstruction using sparse identification of nonlinear dynamics generates the expression: v_{t,corr}=0.031·Lₜ·|S|·tanh(2.4P_{align})+0.018·Lₜ²·|S|^{0.5}·exp(−0.7|P_{align}|), where the first term physically represents enhanced mixing in high-strain regions with favorable pressure gradients, and the second term captures length scale effects in adverse pressure gradient regions. The augmented model predicts post-stall drag coefficients with root mean square error of 0.024 (8.1% relative error) versus 0.071 (24.8% relative error) for the baseline k-ε model, validated on 12 additional airfoil geometries including NACA 23012, NACA 64A010, and Eppler 387 not used in training, with computational speedup of 340× compared to the original neural network implementation.

A second application example demonstrates augmentation of mechanistic models of glycolysis in Saccharomyces cerevisiae for systems biology applications. The mechanistic model comprises 12 ordinary differential equations representing time evolution of metabolite concentrations through the Embden-Meyerhof-Parnas pathway, including glucose, glucose-6-phosphate, fructose-6-phosphate, fructose-1,6-bisphosphate, dihydroxyacetone phosphate, glyceraldehyde-3-phosphate, 1,3-bisphosphoglycerate, 3-phosphoglycerate, 2-phosphoglycerate, phosphoenolpyruvate, pyruvate, and ATP/ADP/AMP nucleotides. The mechanistic model includes 18 enzymatic reactions with Michaelis-Menten rate laws characterized by Kₘ values ranging from 0.05 mM (hexokinase for glucose) to 15.2 mM (pyruvate kinase for phosphoenolpyruvate) and Vmax values from 0.12 μmol/min/mg protein (glucose-6-phosphate isomerase) to 8.7 μmol/min/mg protein (glyceraldehyde-3-phosphate dehydrogenase), with parameters obtained from BRENDA enzyme database and literature sources.

The mechanistic model fails to capture allosteric regulation of phosphofructokinase by ATP (Kᵢ=0.8 mM) and AMP activation (Kₐ=0.15 mM), post-translational modifications of pyruvate kinase involving serine phosphorylation that reduces activity by 65%, and glucose repression effects on enzyme expression levels. The system receives training data from 23 perturbation experiments conducted in continuous culture at dilution rate 0.1 h⁻¹, including glucose pulses (2 g/L to 8 g/L), pH shifts (5.5 to 7.2), temperature variations (25° C. to 37° C.), and ethanol stress conditions (0% to 6% v/v). Each experiment provides time-series measurements of 12 metabolite concentrations obtained via LC-MS/MS with 30-second sampling intervals over 4-hour periods, yielding 480 data points per experiment and 11,040 total measurements with analytical precision of ±3.2% for major metabolites and ±8.1% for phosphorylated intermediates.

The system constructs a hybrid model by embedding a 4-layer neural network with 32, 24, 16, and 8 neurons per layer to provide corrections to reaction rates for three regulated enzymes: hexokinase (EC 2.7.1.1), phosphofructokinase (EC 2.7.1.11), and pyruvate kinase (EC 2.7.1.40). The neural network processes 18 inputs including all 12 metabolite concentrations plus derived regulatory signals: ATP/ADP ratio, ATP/AMP ratio, NADH/NAD⁺ ratio, phosphorylation potential (ATP/(ADP×Pᵢ)), energy charge ((ATP+0.5ADP)/(ATP+ADP+AMP)), and citrate concentration as allosteric effector. Training over 1,200 iterations using L-BFGS optimizer encounters 89 integration failures when corrections exceed ±2.5× baseline reaction rates, causing negative metabolite concentrations that violate mass conservation. After training converges with final loss of 2.3×10⁻⁵, sensitivity analysis identifies 8 influential inputs with importance scores above 0.12: glucose, ATP, ADP, AMP, fructose-6-phosphate, ATP/ADP ratio, energy charge, and phosphorylation potential. Symbolic reconstruction generates Hill-function expressions: v_{PFK,corr}=v_{PFK,base}×(1+2.4×(AMP/0.15)^{1.8}/(1+(AMP/0.15)^{1.8}))×(1/(1+(ATP/0.8)^{2.3})), capturing cooperative AMP activation (Hill coefficient n_{H}=1.8) and ATP inhibition (n_{H}=2.3) with quantitative estimates matching experimental cooperativity measurements within 12% error.

A third application example demonstrates augmentation of chemical reactor models used in styrene polymerization processes for polystyrene production. The mechanistic model comprises material balances for 8 species concentrations (styrene monomer, polystyrene chains of degrees of polymerization 1-6, and dead polymer), energy balance for reactor temperature, and momentum balance for mixing intensity. The model includes 15 elementary reactions: initiation (kᵢ=2.4×10⁻⁵ s⁻¹ at 90° C.), propagation (kₚ=176 L/mol/s at 90° C.), chain transfer to monomer (k_{tr,M}=0.125 L/mol/s), chain transfer to polymer (k_{tr,P}=0.032 L/mol/s), and termination by combination (k_{tc}=1.8×10⁷ L/mol/s) and disproportionation (k_{td}=0.7×10⁷ L/mol/s). Heat transfer correlations use Nusselt number Nu=0.023×Re^{0.8}×Pr^{0.4} for turbulent flow in the 2.5 m³ jacketed reactor, but exhibit systematic temperature prediction errors of 8-15° C. under rapid load changes due to simplified treatment of wall heat transfer resistance and thermal inertia effects.

The system receives training data from 18 months of plant operations at BASF Ludwigshafen comprising 2,847 batch records with measurements every 2 minutes during 6-hour polymerization cycles. Data includes reactor temperature (precision ±0.1° C.), monomer conversion via online NIR spectroscopy (precision ±0.8%), molecular weight distribution via gel permeation chromatography (Mₙ precision ±150 g/mol, M_{w} precision ±400 g/mol), coolant flow rates (±0.05 kg/s), and agitator power consumption (±0.2 kW). Operating conditions span monomer feed rates from 180-420 kg/h, initiator concentrations from 0.05-0.25 mol %, reactor temperatures from 85-95° C., and coolant temperatures from 15-35° C. The system constructs a hybrid model by embedding a 3-layer neural network with 48, 32, and 16 neurons to provide corrections to the energy balance equation, learning thermal dynamics not captured by the simplified heat transfer correlation Nu=0.023×Re^{0.8}×Pr^{0.4}.

Training over 650 iterations using Adam optimizer with learning rate decay from 0.002 to 0.0001 encounters 43 integration failures when temperature corrections exceed ±12° C., causing negative heat capacities or thermal conductivities that violate thermodynamic constraints. The neural network processes 11 inputs: current temperature, monomer conversion, molecular weight averages Mₙ and M_{w}, viscosity, coolant temperature, coolant flow rate, agitator speed, heat generation rate from polymerization, and temperature gradients ∂T/∂r and ∂T/∂z. After training converges with validation loss of 1.8×10⁻⁴, sensitivity analysis identifies 6 influential inputs: temperature difference (T_{reactor}−T_{coolant}), Reynolds number Re=ρND²/μ, viscosity ratio μ/μ_{ref}, conversion-dependent heat capacity, and radial temperature gradient. Symbolic reconstruction generates the expression: Nu_{corr}=Nu_{base}×(1+0.34×(μ/μ_{ref})^{-0.28})×(1+0.19×(X_{conversion})^{1.6})×exp(−0.08×(ΔT/T_{ref})²), where the first correction term accounts for viscosity effects on heat transfer, the second captures conversion-dependent thermal properties, and the third represents temperature-dependent wall resistance. The augmented model reduces temperature prediction error from 4.2° C. RMSE to 1.1° C. RMSE on validation data spanning 6 months of operation not used in training. Model predictive control implementation using the augmented model achieves ±0.5° C. temperature control versus ±2.1° C. with the baseline model, reducing off-specification product from 3.2% to 0.8% of total production and increasing reactor throughput by 12% through more aggressive temperature profiles enabled by improved prediction accuracy.

### Alternatives and Variations

Alternative universal approximators may replace multi-layer neural networks while maintaining the core functionality of automated augmentation with integration failure monitoring. Chebyshev polynomial approximators may provide function approximation capabilities through orthogonal polynomial basis functions that offer superior numerical conditioning compared to standard polynomial expansions. The Chebyshev approximators may comprise series expansions using Chebyshev polynomials of the first kind, where coefficients become the adjustable parameters optimized during the training process. The orthogonal properties of Chebyshev polynomials may reduce numerical instabilities during parameter optimization and provide more stable convergence behavior in gradient-based training algorithms.

Random forest approximators may serve as universal approximators through ensembles of decision trees that partition the input space into regions with constant output values. Each decision tree may learn nonlinear mappings between inputs and outputs through recursive binary splits based on input variable thresholds. The random forest may combine predictions from multiple trees through averaging operations that reduce overfitting and improve generalization performance. The tree-based structure may provide inherent interpretability advantages over neural networks, as decision paths through trees correspond to logical rules relating inputs to outputs.

Gaussian process approximators may provide probabilistic function approximation through kernel-based methods that model uncertainty in predictions. The Gaussian process may define prior distributions over functions using covariance kernels that encode assumptions about smoothness and correlation structure in the underlying relationships. Training may involve optimizing kernel hyperparameters and computing posterior distributions that provide both mean predictions and uncertainty estimates. The uncertainty quantification may enable more robust integration failure detection by identifying parameter regions where model predictions become unreliable.

Support vector machine approximators may provide function approximation through kernel methods that map inputs to high-dimensional feature spaces where linear relationships may capture complex nonlinear behavior in the original input space. The support vector regression formulation may optimize margin-based loss functions that provide robustness to outliers in training data. The kernel functions may include radial basis functions, polynomial kernels, or custom kernels designed for specific application domains.

Radial basis function networks may approximate functions through weighted combinations of radial basis functions centered at specific locations in the input space. The radial basis functions may comprise Gaussian functions, multiquadric functions, or thin plate splines that provide localized approximation capabilities. Training may involve optimizing both the center locations and the weights associated with each basis function. The localized nature of radial basis functions may provide better extrapolation behavior compared to global approximators such as polynomial expansions.

Alternative optimization algorithms may replace gradient-based optimization methods while maintaining integration failure monitoring capabilities. Genetic algorithms may optimize universal approximator parameters through evolutionary processes that mimic natural selection mechanisms. The genetic algorithm may maintain populations of candidate parameter sets and apply selection, crossover, and mutation operations to generate improved parameter configurations. The population-based approach may provide natural robustness to integration failures by maintaining multiple candidate solutions simultaneously.

Particle swarm optimization may optimize parameters through swarm intelligence algorithms that simulate collective behavior of social organisms. Each particle in the swarm may represent a candidate parameter configuration that moves through parameter space based on personal best positions and global best positions discovered by the swarm. The swarm-based approach may provide global optimization capabilities that avoid local minima encountered by gradient-based methods.

Simulated annealing may optimize parameters through probabilistic algorithms that accept parameter updates based on temperature-dependent acceptance probabilities. The algorithm may initially accept parameter updates that increase the loss function, allowing exploration of parameter space, then gradually reduce the acceptance probability to converge toward optimal solutions. The probabilistic acceptance mechanism may enable the algorithm to escape local minima and find globally optimal parameter configurations.

Bayesian optimization may optimize parameters through probabilistic models that balance exploration and exploitation during the search process. The algorithm may maintain probabilistic models of the loss function surface and use acquisition functions to select parameter configurations that maximize expected improvement. The Bayesian approach may be particularly effective when function evaluations are expensive, as occurs when numerical integration requires substantial computational time.

Differential evolution may optimize parameters through population-based algorithms that generate new candidate solutions by combining existing population members through differential mutation and crossover operations. The algorithm may maintain diversity in the population while directing search toward promising regions of parameter space. The differential evolution approach may provide robust optimization performance across diverse problem types without requiring gradient information.

Alternative symbolic reconstruction methods may replace sparse identification of nonlinear dynamics while maintaining the goal of generating interpretable mathematical expressions. Genetic programming may evolve symbolic expressions through evolutionary algorithms that treat mathematical expressions as individuals in a population. The genetic programming algorithm may apply crossover operations that exchange subtrees between expressions and mutation operations that modify individual nodes or subtrees. The fitness evaluation may measure how well each expression approximates the universal approximator behavior on training data.

The genetic programming approach may use function sets comprising arithmetic operators, trigonometric functions, exponential functions, and logarithmic functions as building blocks for expression construction. The algorithm may enforce constraints on expression complexity through parsimony pressure that penalizes overly complex expressions during fitness evaluation. The evolutionary process may discover novel mathematical relationships that would not be found through library-based approaches such as sparse identification of nonlinear dynamics.

Symbolic regression through reinforcement learning may generate mathematical expressions by training agents to construct expressions through sequential decision-making processes. The reinforcement learning agent may select mathematical operators and operands at each step to build expressions that maximize rewards based on approximation accuracy and expression simplicity. The sequential construction process may enable the discovery of hierarchical mathematical structures that capture complex relationships between inputs and outputs.

Grammar-based genetic programming may constrain expression generation through formal grammars that define valid mathematical expression structures. The grammar may specify production rules that determine how mathematical expressions may be constructed from primitive components. The grammar-based approach may ensure that generated expressions satisfy syntactic constraints and domain-specific requirements such as dimensional consistency or physical realizability.

Multi-objective optimization approaches may balance multiple criteria during symbolic reconstruction, including approximation accuracy, expression complexity, and interpretability measures. The multi-objective algorithms may generate Pareto-optimal sets of expressions that represent different trade-offs between competing objectives. The Pareto front may enable users to select expressions based on application-specific preferences for accuracy versus interpretability.

Various system components may be modified or substituted while maintaining core functionality. Alternative numerical integration algorithms may replace standard methods, including adaptive step-size algorithms, implicit-explicit methods for mixed stiff-nonstiff systems, or specialized algorithms for differential algebraic equations with higher index. The integration failure monitoring may adapt to different failure modes specific to each integration algorithm.

Alternative loss function formulations may replace standard mean squared error objectives, including robust loss functions that reduce sensitivity to outliers, physics-informed loss functions that incorporate conservation laws or boundary conditions, or multi-scale loss functions that weight different time scales or frequency components differently. The infinite penalty assignment may apply to any loss function formulation when integration failures occur.

Alternative sensitivity analysis methods may replace Jacobian-based approaches, including finite difference sensitivity analysis, adjoint sensitivity methods, or variance-based sensitivity analysis techniques such as Sobol indices. The sensitivity analysis may identify influential variables regardless of the specific mathematical approach used to quantify variable importance.

Alternative data preprocessing methods may replace standard normalization approaches, including robust scaling methods that use median and interquartile range instead of mean and standard deviation, or domain-specific scaling methods that account for physical units or conservation constraints. The preprocessing methods may improve training stability and convergence behavior while maintaining compatibility with integration failure monitoring.

Alternative model validation approaches may replace simple train-test splits, including cross-validation methods that account for temporal correlations in time series data, bootstrap validation methods that assess uncertainty in model performance metrics, or domain-specific validation approaches that test model performance under extrapolation conditions relevant to the target application.

The computing architecture may be modified to accommodate different hardware configurations, including distributed computing systems that parallelize training across multiple nodes, specialized hardware accelerators such as tensor processing units or field-programmable gate arrays, or cloud-based computing platforms that provide scalable computational resources. The integration failure monitoring may operate across different computing architectures while maintaining the same logical functionality.

1. A computer-implemented system for automated augmentation of differential equation models, the system comprising:
at least one processor;
a memory storing a system of differential equations representing mechanistic behavior of a physical or computational process; and
the memory further storing executable instructions that, when executed by the at least one processor, cause the system to:
construct, in the memory, a hybrid computational solver by embedding a trainable universal approximator comprising a plurality of adjustable parameters into the system of differential equations such that outputs of the universal approximator computationally augment time derivatives of differential variables during numerical integration;
execute an iterative training process that adjusts the plurality of parameters by:
performing numerical integration of the hybrid computational solver over time intervals specified by training data;
monitoring the numerical integration for integration failures or numerical instabilities;
computing a loss function value and providing the loss function value to an optimization algorithm, wherein detecting an integration failure causes assignment of an infinite penalty value as the loss function value that causes an optimization algorithm to reject the corresponding parameter update; and
computing one or more gradients of the loss function with respect to the plurality of parameters using automatic differentiation when no integration failure is detected;
compute, using the at least one processor, sensitivity metrics by:
evaluating a Jacobian matrix of the universal approximator with respect to inputs at multiple time points during execution of the hybrid computational solver to compute input sensitivity measures; and
iteratively setting each output of the universal approximator to zero and measuring resulting change in model accuracy to compute output sensitivity measures;
classify a subset of inputs and a subset of outputs of the universal approximator as significant based on the sensitivity metrics exceeding a threshold value;
generate, in the memory, a computationally reduced approximator having fewer computational operations than the universal approximator, wherein the reduced approximator operates only on the classified subset of inputs to produce only the classified subset of outputs; and
replace, in the hybrid computational solver, the universal approximator with the reduced approximator to create an optimized solver requiring reduced computational resources during execution.

2. The system of claim 1, wherein the instructions further cause the system to:
normalize inputs to the universal approximator by scaling each input based on at least one of user-specified scaling constants or statistical measures computed from execution of the system of differential equations without the universal approximator, wherein the statistical measures comprise at least one of mean values, standard deviations, or z-scores; and
normalize outputs of the universal approximator by scaling each output based on at least one of user-specified scaling values or typical magnitudes of derivative corrections computed from the system of differential equations without the universal approximator to prevent destabilization of the numerical integration.

3. The system of claim 1, wherein:
the system of differential equations comprises differential algebraic equations (DAEs) including both differential variables and algebraic constraints; and
the outputs of the universal approximator augment only the time derivatives of the differential variables and not the algebraic constraints, thereby maintaining mathematical consistency of the algebraic constraints during the numerical integration.

4. The system of claim 1, wherein the universal approximator comprises a multi-layer neural network having a plurality of layers with nonlinear activation functions, and wherein the reduced approximator comprises a symbolic mathematical expression containing polynomial terms, exponential terms, or trigonometric terms that approximate behavior of the multi-layer neural network.

5. The system of claim 1, wherein computing gradients using automatic differentiation comprises:
executing reverse-mode automatic differentiation through the numerical integration; and
computing adjoint sensitivities of the loss function with respect to the plurality of parameters using parallel computational operations.

6. The system of claim 1, wherein classifying the subset of outputs comprises:
iteratively masking individual outputs of the universal approximator;
for each masked output, executing the hybrid computational solver and computing a deviation metric indicating change in model accuracy; and
selecting outputs as significant when the deviation metric exceeds a significance threshold.

7. The system of claim 1, wherein generating the reduced approximator comprises: applying sparse identification of nonlinear dynamics (SINDy) to identify a sparse set of basis functions from a predetermined library of candidate functions; determining coefficients for the sparse set of basis functions using regression techniques; and constructing the reduced approximator as a linear combination of the sparse set of basis functions with the determined coefficients.

8. The system of claim 1, wherein the system of differential equations models at least one of: turbulent fluid flow in an industrial process, biological pathway dynamics in a metabolic network, thermal dynamics in an electric vehicle battery system, or chemical reaction kinetics in a pharmaceutical manufacturing process.

9. The system of claim 1, wherein the training data comprises multiple distinct datasets representing different operating conditions or parameter values, and wherein the iterative training process simultaneously optimizes the plurality of parameters to minimize prediction error across all of the multiple distinct datasets.

10. The system of claim 1, wherein the instructions further cause the system to:
evaluate predictive accuracy of the optimized solver using validation data not included in the training data; and
in response to the predictive accuracy falling below an accuracy threshold, re-execute the iterative training process with modified hyperparameters or additional training data.

11. A computer-implemented method for augmenting computational models of physical systems, the method comprising:
receiving, at a computing system comprising at least one processor, a system of differential equations and training data representing observed behavior of a physical system;
constructing, by the at least one processor, a hybrid solver in memory by:
embedding a universal approximator comprising a plurality of adjustable parameters into the system of differential equations; and
configuring the hybrid solver such that outputs of the universal approximator computationally augment time derivatives of differential variables during numerical integration operations;
executing a training loop comprising a plurality of iterations, wherein each iteration comprises:
performing numerical integration of the hybrid solver using a numerical integration algorithm;
monitoring the numerical integration for integration failures or numerical instabilities;
computing a loss function value and providing the loss function value to an optimization algorithm, wherein detecting an integration failure causes assignment of an infinite penalty value as the loss function value that causes an optimization algorithm to reject the corresponding parameter update; and
when no integration failure is detected, computing parameter gradients using automatic differentiation and updating parameters of the universal approximator using gradient-based optimization;
computing, by the at least one processor, input sensitivity measures by:
evaluating absolute values of partial derivatives of the universal approximator outputs with respect to each input at multiple time points; and
averaging the absolute values over the multiple time points to produce an input importance score for each input;
selecting a subset of inputs having input importance scores exceeding a threshold value;
computing, by the at least one processor, output sensitivity measures by:
iteratively setting each output of the universal approximator to zero and measuring resulting change in model accuracy; and
ranking outputs based on magnitude of the resulting change;
selecting a subset of outputs having highest rankings;
generating a reduced approximator by applying symbolic regression to learn a mathematical function mapping the subset of inputs to the subset of outputs;
replacing the parameterized universal approximator in the hybrid solver with the symbolic approximator; and
storing the hybrid solver with the reduced approximator as an optimized solver, wherein the optimized solver is stored as an executable model for simulating the physical system.

12. The method of claim 11, wherein the numerical integration algorithm comprises at least one of a Runge-Kutta method, a backward differentiation formula (BDF) method or a Rosenbrock method for stiff systems.

13. The method of claim 11, wherein when no integration failure is detected, the training loop computes a loss function as a weighted sum of:
a data-fitting term measuring deviation between hybrid solver outputs and the training data;
a regularization term penalizing large parameter values; and
a smoothness term penalizing rapid variations in outputs of the universal approximator over time.

14. The method of claim 11, further comprising:
allocating memory for storing state variables, parameters of the universal approximator, and intermediate integration results;
batching multiple numerical integration operations to execute in parallel; and
using optimized libraries for matrix operations required in the automatic differentiation.

15. The method of claim 11, further comprising:
after replacing the parameterized universal approximator with the symbolic approximator, executing the hybrid solver on validation data representing different operating conditions than the training data;
computing a validation error metric; and
in response to the validation error metric exceeding an error threshold, iteratively refining the symbolic approximator by expanding a library of candidate symbolic functions.

16. A non-transitory computer-readable storage medium storing instructions that, when executed by a computing system comprising at least one processor, cause the computing system to:
load a system of differential equations representing mechanistic knowledge of a dynamical system;
construct a hybrid solver by embedding a universal approximator comprising adjustable parameters into the differential equations such that outputs of the universal approximator computationally augment time derivatives of differential variables during numerical integration;
train the adjustable parameters by iteratively:
executing numerical integration of the hybrid solver;
monitoring the numerical integration for integration failures or numerical instabilities;
computing a loss function value and providing the loss function value to an optimization algorithm, wherein detecting an integration failure causes assignment of an infinite penalty value as the loss function value that causes an optimization algorithm to reject the corresponding parameter update; and
computing and applying parameter updates using gradients computed via automatic differentiation if no integration failure occurs;
after training converges, analyze the trained universal approximator by:
computing input sensitivity measures by evaluating a Jacobian matrix of the universal approximator with respect to inputs at multiple time points;
computing output sensitivity measures by iteratively setting each output to zero and measuring resulting change in model accuracy; and
selecting a subset of inputs and a subset of outputs based on the sensitivity measures exceeding a threshold value;
construct a reduced approximator having fewer computational operations than the universal approximator, wherein the reduced approximator operates only on the classified subset of inputs to produce only the classified subset of outputs; and
generate an optimized executable model by replacing the universal approximator with the reduced approximator.

17. The storage medium of claim 16, wherein performing output masking experiments comprises, for each output of the universal approximator:
temporarily setting that output to zero in the hybrid solver;
executing the hybrid solver with the temporarily zeroed output;
computing a deviation score measuring difference between outputs with and without the zeroed output; and
classifying the output as influential if the deviation score exceeds a predetermined threshold.

18. The storage medium of claim 16, wherein constructing the reduced approximator comprises:
defining a library of candidate symbolic functions including polynomial terms, trigonometric functions, exponential functions, and logarithmic functions;
generating a dataset by evaluating the trained universal approximator at a plurality of input points;
applying a sparse regression algorithm to select a sparse subset of candidate symbolic functions from the library that collectively approximate the dataset; and
determining coefficients for the sparse subset using least-squares optimization.

19. The storage medium of claim 16, wherein the instructions further cause the computing system to:
after generating the optimized executable model, perform re-optimization by:
treating coefficients in the reduced approximator as tunable parameters;
executing a second training process that adjusts the coefficients to minimize prediction error on the training data; and
storing the re-optimized coefficients in the optimized executable model.

20. The storage medium of claim 16, wherein:
the dynamical system is an industrial process control system;
the system of differential equations represents at least one of: chemical reactor dynamics, distillation column operation, heat exchanger networks, or pipeline flow systems; and
the optimized executable model is deployed in a real-time process control system that executes the hybrid solver to compute control actions at update rates of at least 1 Hz.
